(19) United States
(12) Patent Application Publication
(10) Pub. No.: US 2025/0181465 A1
(43) Pub. Date: Jun. 5, 2025

(54) Asynchronous modeled system to perform graph analytics on fault-tolerant environments

(71) Applicant: International Business Machines Corporation, Armonk, NY (US)

(72) Inventors: Lior Horesh, North Salem, NY (US); Vasileios Kalantzis, White Plains, NY (US); Georgios Kollias, White Plains, NY (US); Shashanka Ubaru, Ossining, NY (US); Chai Wah Wu, HOPEWELL JUNCTION, NY (US)

(21) Appl. No.: 18/527,476

(22) Filed: Dec. 4, 2023

(51) Int. Cl. G06F 11/263

(52) U.S. Cl. CPC G06F 11/263

(57) ABSTRACT

A system for randomized trace approximation calculation based on asynchronous computing architecture is disclosed. The system retrieves an adjacency matrix associated with a complex graph. The system determines a random vector based on the retrieved adjacency matrix. The system generates a matrix-vector based on the adjacency matrix and the random vector. The system determines a first set of natural numbers based on the first dimension of the adjacency matrix. The system selects a subset of entries from the generated matrix-vector based on the determined first set of natural numbers. The system determines a diagonal random matrix based on a summation of canonical outer products formed by the selected subset of entries. The system calculates a trace approximation of the adjacency matrix based on the determined diagonal random matrix and the selected subset of entries and stores the calculated trace approximation of the adjacency matrix.

### BACKGROUND

The present disclosure relates to trace approximation calculation and, more particularly, to a randomized trace approximation calculation based on an asynchronous computing architecture.

With advancements in the field of computer science and linear algebra, many real-world problems in different fields such as, but not limited to, networks and telecommunications, transportation and logistics, epidemiology, computer science and information technology, biology and genetics, finance, circuit design, energy networks, and image processing and computer vision are now being framed as graph theory problems in which the real-world problems are represented by graphs. The graphs are mathematical structures composed of nodes (vertices) and edges that connect these nodes. These graphs provide a flexible framework for modeling, analyzing, and solving real-world problems. The graphs can also be represented in the form of a matrix and different operations may be performed on the matrix to solve the real-world problems. One such operation is called trace estimation of the matrix.

Traditionally, calculating the trace of an implicitly defined matrix A is computationally expensive, especially for large-scale graphs. Existing methods typically involve either direct computation, which can be time-consuming for dense graphs, or full matrix diagonalization, which is computationally intensive and memory demanding.

### SUMMARY

According to an embodiment of the present disclosure, a computer-implemented method for calculating a trace approximation of an adjacency matrix is described. The computer-implemented method includes retrieving, by a computer, an adjacency matrix associated with a complex graph. The retrieved adjacency matrix may be of a first dimension. The computer-implemented method further includes determining, by the computer, a random vector based on the retrieved adjacency matrix. The random vector may have an expectation value of zero. The computer-implemented method further includes generating, by the computer, a matrix-vector based on the retrieved adjacency matrix and the determined random vector. The computer-implemented method further includes determining, by the computer, a first set of natural numbers based on the first dimension of the retrieved adjacency matrix. The count of elements in the determined first set of natural numbers may be less than the first dimension of the retrieved adjacency matrix. The computer-implemented method further includes selecting, by the computer, a subset of entries from the generated matrix-vector based on the determined first set of natural numbers. The computer-implemented method further includes determining, by the computer, a diagonal random matrix based on a summation of canonical outer products formed by the selected subset of entries. The computer-implemented method further includes calculating, by the computer, a trace approximation of the adjacency matrix based on the determined diagonal random matrix and the selected subset of entries and storing, by the computer, the calculated trace approximation of the adjacency matrix.

According to one or more embodiments of the present disclosure, a system for calculation of a trace approximation of an adjacency matrix is described. The computer performs a method for calculating a trace approximation of an adjacency matrix. The method includes retrieving an adjacency matrix associated with a complex graph. The retrieved adjacency matrix may be of a first dimension. The method further includes determining a random vector based on the retrieved adjacency matrix. The random vector may have an expectation value of zero. The method further includes generating a matrix-vector based on the retrieved adjacency matrix and the determined random vector. The method further includes determining a first set of natural numbers based on the first dimension of the retrieved adjacency matrix. The count of elements in the determined first set of natural numbers may be less than the first dimension of the retrieved adjacency matrix. The method further includes selecting a subset of entries from the generated matrix-vector based on the determined first set of natural numbers. The method further includes determining a diagonal random matrix based on a summation of canonical outer products formed by the selected subset of entries. The method further includes calculating a trace approximation of the adjacency matrix based on the determined diagonal random matrix and the selected subset of entries and storing the calculated trace approximation of the adjacency matrix.

According to one or more embodiments of the present disclosure, a computer program product for calculating a trace approximation of an adjacency matrix is described. The computer program product includes a computer-readable storage medium having program instructions embodied therewith, the program instructions executable by a system to cause the system to retrieve an adjacency matrix associated with a complex graph. The retrieved adjacency matrix may be of a first dimension. The program instructions further includes determining, by the computer, a random vector based on the retrieved adjacency matrix. The random vector may have an expectation value of zero. The program instructions further includes generating, by the computer, a matrix-vector based on the retrieved adjacency matrix and the determined random vector. The program instructions further includes determining a first set of natural numbers based on the first dimension of the retrieved adjacency matrix. The count of elements in the determined first set of natural numbers may be less than the first dimension of the retrieved adjacency matrix. The program instructions further includes selecting a subset of entries from the generated matrix-vector based on the determined first set of natural numbers. The program instructions further include determining a diagonal random matrix based on a summation of canonical outer products formed by the selected subset of entries. The program instructions further include calculating a trace approximation of the adjacency matrix based on the determined diagonal random matrix and the selected subset of entries and storing the calculated trace approximation of the adjacency matrix.

According to one or more embodiments of the present disclosure, a system for calculation of a trace approximation of an adjacency matrix is described. The computer performs a method for calculating a trace approximation of an adjacency matrix. The method includes retrieving an adjacency matrix associated with a complex graph. The retrieved adjacency matrix may be of a first dimension. The system determines at least one trigger point based on at least one of a computational power of the system or detection of one or more faults associated with one or more calculations performed by the system. The method further includes determining a random vector based on the retrieved adjacency matrix and the determined at least one trigger point. The random vector may have an expectation value of zero. The method further includes generating a matrix-vector based on the retrieved adjacency matrix and the determined random vector. The method further includes determining a first set of natural numbers based on the first dimension of the retrieved adjacency matrix. The count of elements in the determined first set of natural numbers may be less than the first dimension of the retrieved adjacency matrix. The method further includes selecting a subset of entries from the generated matrix-vector based on the determined first set of natural numbers. The method further includes determining a diagonal random matrix based on a summation of canonical outer products formed by the selected subset of entries. The method further includes calculating a trace approximation of the adjacency matrix based on the determined diagonal random matrix and the selected subset of entries and storing the calculated trace approximation of the adjacency matrix.

According to an embodiment of the present disclosure, a computer-implemented method for calculating a trace approximation of an adjacency matrix is described. The computer-implemented method includes retrieving, by a computer, an adjacency matrix associated with a complex graph. The retrieved adjacency matrix may be of a first dimension. The computer-implemented method further includes determining at least one trigger point based on at least one of a computational power of the computer or detection of one or more faults associated with one or more calculations performed by the computer. The computer-implemented method further includes determining, by the computer, a random vector based on the retrieved adjacency matrix and the determined at least one trigger point. The random vector may have an expectation value of zero. The computer-implemented method further includes generating, by the computer, a matrix-vector based on the retrieved adjacency matrix and the determined random vector. The computer-implemented method further includes determining, by the computer, a first set of natural numbers based on the first dimension of the retrieved adjacency matrix. The count of elements in the determined first set of natural numbers may be less than the first dimension of the retrieved adjacency matrix. The computer-implemented method further includes selecting, by the computer, a subset of entries from the generated matrix-vector based on the determined first set of natural numbers. The computer-implemented method further includes determining, by the computer, a diagonal random matrix based on a summation of canonical outer products formed by the selected subset of entries. The computer-implemented method further includes calculating, by the computer, a trace approximation of the adjacency matrix based on the determined diagonal random matrix and the selected subset of entries and storing, by the computer, the calculated trace approximation of the adjacency matrix.

Some embodiments of the disclosure describes an application of randomized trace estimators on asynchronous computing environments where the quadratic form x^{T}Ax is computed partially by observing only a random row subset of the adjacency matrix (A) for each sample of the random vector (x). The disclosed asynchronous framework treats the number of rows as well as the row subset observed for each sample as random variables, and our theoretical analysis establishes the variance of the randomized estimator for Rademacher and Gaussian samples.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for randomized trace approximation calculation based on asynchronous computing architecture, in accordance with an embodiment of the disclosure;

FIG. 1 is a diagram that illustrates a network environment for randomized trace approximation calculation based on asynchronous computing architecture, in accordance with an embodiment of the disclosure;

FIG. 2 is a diagram that illustrates an environment for randomized trace approximation calculation based on asynchronous computing architecture, in accordance with an embodiment of the disclosure;

FIG. 3 depicts an exemplary complex graph and an exemplary adjacency matrix associated with the exemplary complex graph, in accordance with an embodiment of the disclosure;

FIG. 4A is a diagram that illustrates exemplary operations for determination of computational power of an underlying electronic device, in accordance with an embodiment of the disclosure;

FIG. 4B is a diagram that illustrates exemplary operations for determination of one or more faults associated with one or more calculations performed by at least one electronic device, in accordance with an embodiment of the disclosure;

FIG. 5 is a diagram that illustrates exemplary operations for randomized trace approximation calculation based on asynchronous computing architecture, in accordance with an embodiment of the disclosure;

FIG. 6 is an exemplary diagram that illustrates an exemplary use case scenario for randomized trace approximation, in accordance with an embodiment of the disclosure;

FIG. 7 is an exemplary diagram of graphs between a number of samples and relative error, in accordance with an embodiment of the disclosure;

FIG. 8 is a flowchart that illustrates an exemplary method for randomized trace approximation calculation based on asynchronous computing architecture, in accordance with an embodiment of the disclosure; and

FIG. 9 is a flowchart that illustrates an exemplary method for randomized trace approximation calculation based on asynchronous computing architecture, in accordance with an embodiment of the disclosure.

### DETAILED DESCRIPTION

According to an aspect of the present disclosure, there is provided a computer-implemented method for calculating a trace approximation of an adjacency matrix. The computer-implemented method includes retrieving, by a computer, an adjacency matrix associated with a complex graph. The retrieved adjacency matrix may be of a first dimension. The computer-implemented method further includes determining, by the computer, a random vector based on the retrieved adjacency matrix. The random vector may be sampled based on one of a Rademacher distribution or a Gaussian distribution and may have an expectation value and a variance of zero. The computer-implemented method further includes generating, by the computer, a matrix-vector based on the retrieved adjacency matrix and the determined random vector. The computer-implemented method further includes determining, by the computer, a first set of natural numbers based on the first dimension of the retrieved adjacency matrix. The count of elements in the determined first set of natural numbers may be less than the first dimension of the retrieved adjacency matrix. The computer-implemented method further includes selecting, by the computer, a subset of entries from the generated matrix-vector based on the determined first set of natural numbers. The computer-implemented method further includes determining, by the computer, a diagonal random matrix based on a summation of canonical outer products formed by the selected subset of entries. The computer-implemented method further includes calculating, by the computer, a trace approximation of the adjacency matrix based on the determined diagonal random matrix and the selected subset of entries. Specifically, the computer-implemented method includes iteratively selecting, by the computer, the subset of entries from the generated matrix-vector based on the determined first set of natural numbers. The computer-implemented method further includes iteratively determining, by the computer, the diagonal random matrix based on the summation of the canonical outer products formed by the corresponding subset of entries. The computer-implemented method further includes calculating, by the computer, the trace approximation of the adjacency matrix based on an average of a set of intermediate results obtained based on the iterative selection of the subset of entries and the iterative determination of the diagonal random matrix. The computer-implemented method further includes storing, by the computer, the calculated trace approximation of the adjacency matrix. By selecting a subset of entries from the matrix-vector product and by performing the iterative calculations in parallel, the computational power and the storage requirements may be reduced. This may enable efficient processing of adjacency matrices with huge dimensions for calculating the corresponding trace estimations. Due to parallel processing of limited set of entries, the disclosed computer-implemented method may calculate the randomized trace of the adjacency matrix quickly and efficiently. This may further lead to resource optimization and cost savings. Furthermore, due to iterative selection of the subset of entries and further iterative determination of the diagonal random matrix to cover the variations (or variety) of the natural numbers and further average out to calculate the trace approximation of the adjacency matrix. This may ensure that the trace approximation is not skewed due to selection of only a single set of natural numbers.

In other embodiments, the computer-implemented method further includes generating, by the computer, a solution of a graph analysis problem based on the calculated trace approximation of the adjacency matrix, where the complex graph is associated with the graph analysis problem. Time taken to generate the solution of the graph analysis problem using the disclosed trace estimation technique may be less as compared to the time taken generate the solution of the graph analysis problem using the traditional trace estimation techniques due to the processing of limited set of rows as discuss above. This may be further utilized in solving the real-life problems in real-time (or almost near real-time).

In other embodiments, the graph analysis problem corresponds to one of a graph traversal problem, a network routing problem, a social network analysis problem, a protein folding problem, a graph centrality problem, a sorting problem, or a graph classification problem.

In other embodiments, the computer-implemented method further includes generating, by the computer, the matrix-vector based on the retrieved adjacency matrix, the determined random vector, and the first set of natural numbers, where at least one row of the retrieved adjacency matrix is updated by a zero-row vector in the generated matrix-vector based on a determination of an absence of a corresponding row number associated with the at least one row of an initial matrix-vector from the first set of natural numbers. As a result, the disclosed computer-implemented method may update some rows of the matrix vector with the zero-row vector. During parallel calculations, the disclosed method may omit rows updated with zero vector so that the calculations for trace estimation of the adjacency may be done quickly, efficiently, and effectively using reduced number of rows to process.

In other embodiments, the computer-implemented method further includes determining, by the computer, a computational power of at least one electronic device. The computer-implemented method further includes selecting, by the computer, the subset of entries from the generated matrix-vector based on the determined computational power of the electronic device. The disclosed computer-implemented method may initially determine the computational power of the electronic device and further select the subset of entries from the generated matrix-vector for the calculation of the trace estimation. Due to parallel calculations and omission of some rows for calculation, the disclosed computer-implemented method may execute on electronic devices with low computational power. Therefore, the trace of the adjacency matrix may be calculated even on low-end devices that may have low computational power.

In other embodiments, the computer-implemented method further includes detecting, by the computer, one or more faults associated with one or more calculations performed by at least one electronic device. The computer-implemented method further includes selecting, by the computer, the subset of entries from the generated matrix-vector based on the detection of the one or more faults. The disclosed computer-implemented method may initially determine the one or more faults associated with one or more calculations performed by electronic devices and further select the subset of entries from the generated matrix-vector for trace estimation. As a result, even if there are faults present in the electronic device, the disclosed computer-implemented method may update the adjacency matrix by the zero-row vector in the generated matrix-vector due to detected one or more faults in the electronic device. The entries that are updated by the zero-row vector may be omitted for processing during the calculation of the trace estimation. Due to the omission, the time taken to calculate the trace approximation may be reduced to an extent. Furthermore, in the event of faults within the electronic device, the computer-implemented method can be seamlessly executed, as the identified faults are unlikely to significantly affect the overall outcome of the trace approximation.

According to an aspect of the present disclosure, there is provided a system for calculation of a trace approximation of an adjacency matrix. The system performs a method for calculating a trace approximation of an adjacency matrix. The method includes retrieving an adjacency matrix associated with a complex graph. The retrieved adjacency matrix may be of a first dimension. The method further includes determining a random vector based on the retrieved adjacency matrix. The random vector may be sampled based on one of a Rademacher distribution or a Gaussian distribution and may have an expectation value and a variance of zero. The method further includes generating a matrix-vector based on the retrieved adjacency matrix and the determined random vector. The method further includes determining a first set of natural numbers based on the first dimension of the retrieved adjacency matrix. The count of elements in the determined first set of natural numbers may be less than the first dimension of the retrieved adjacency matrix. The method further includes selecting a subset of entries from the generated matrix-vector based on the determined first set of natural numbers. The method further includes determining a diagonal random matrix based on a summation of canonical outer products formed by the selected subset of entries. The method further includes calculating a trace approximation of the adjacency matrix based on the determined diagonal random matrix and the selected subset of entries. Specifically, the method includes iteratively selecting the subset of entries from the generated matrix-vector based on the determined first set of natural numbers. The method further includes iteratively determining the diagonal random matrix based on the summation of the canonical outer products formed by the corresponding subset of entries. The method further includes calculating the trace approximation of the adjacency matrix based on an average of a set of intermediate results obtained based on the iterative selection of the subset of entries and the iterative determination of the diagonal random matrix. The method further includes storing the calculated trace approximation of the adjacency matrix. By selecting a subset of entries from the matrix-vector product and by performing the iterative calculations in parallel, the computational power and the storage requirements may be reduced. This may enable processing of adjacency matrices with huge dimensions for calculating the corresponding trace estimations. Due to parallel processing of limited set of entries, the disclosed system may calculate the randomized trace of the adjacency matrix quickly and efficiently. This may further lead to resource optimization and cost savings. Furthermore, due to iterative selection of the subset of entries and further iterative determination of the diagonal random matrix to cover the variations (or variety) of the natural numbers and further average out to calculate the trace approximation of the adjacency matrix. This may ensure that the trace approximation is not skewed due to selection of only a single set of natural numbers.

In other embodiments, the method further includes selecting a subset of entries from the generated matrix-vector based on processor set information, where the processor set information indicates a count of processors in the processor set. The method further includes determining the diagonal random matrix based on the summation of canonical outer products formed by the selected subset of entries. Due to this the calculations may be performed in the asynchronous manner or in parallel on each processor of the processor set. Such parallel calculations may reduce the time taken to calculate the trace approximation of the adjacency matrix.

According to an aspect of the present disclosure, there is provided a computer program product for calculating a trace approximation of an adjacency matrix. The computer program product includes a computer-readable storage medium having program instructions embodied therewith, the program instructions executable by a system to cause the system to retrieve an adjacency matrix associated with a complex graph. The retrieved adjacency matrix may be of a first dimension. The program instructions further includes determining, by the computer, a random vector based on the retrieved adjacency matrix. The random vector may have an expectation value of zero. The program instructions further includes generating, by the computer, a matrix-vector based on the retrieved adjacency matrix and the determined random vector. The program instructions further includes determining a first set of natural numbers based on the first dimension of the retrieved adjacency matrix. The count of elements in the determined first set of natural numbers may be less than the first dimension of the retrieved adjacency matrix. The program instructions further includes selecting a subset of entries from the generated matrix-vector based on the determined first set of natural numbers. The program instructions further include determining a diagonal random matrix based on a summation of canonical outer products formed by the selected subset of entries. The program instructions further include calculating a trace approximation of the adjacency matrix based on the determined diagonal random matrix and the selected subset of entries and storing the calculated trace approximation of the adjacency matrix. By selecting a subset of entries from the matrix-vector product and by performing the iterative calculations in parallel, the computational power and the storage requirements may be reduced. This may enable processing of adjacency matrices with huge dimensions for calculating the corresponding trace estimations. Due to parallel processing of limited set of entries, the disclosed computer programmable product may calculate the randomized trace of the adjacency matrix quickly and efficiently. This may further lead to resource optimization and cost savings. Furthermore, due to iterative selection of the subset of entries and further iterative determination of the diagonal random matrix to cover the variations (or variety) of the natural numbers and further average out to calculate the trace approximation of the adjacency matrix. This may ensure that the trace approximation is not skewed due to selection of only a single set of natural numbers.

According to an aspect of the present disclosure, there is provided a system for calculation of a trace approximation of an adjacency matrix. The computer performs a method for calculating a trace approximation of an adjacency matrix. The method includes retrieving an adjacency matrix associated with a complex graph. The retrieved adjacency matrix may be of a first dimension. The system determines at least one trigger point based on at least one of a computational power of the system or detection of one or more faults associated with one or more calculations performed by the system. The method further includes determining a random vector based on the retrieved adjacency matrix and the determined at least one trigger point. The random vector may have an expectation value of zero. The method further includes generating a matrix-vector based on the retrieved adjacency matrix and the determined random vector. The method further includes determining a first set of natural numbers based on the first dimension of the retrieved adjacency matrix. The count of elements in the determined first set of natural numbers may be less than the first dimension of the retrieved adjacency matrix. The method further includes selecting a subset of entries from the generated matrix-vector based on the determined first set of natural numbers. The method further includes determining a diagonal random matrix based on a summation of canonical outer products formed by the selected subset of entries. The method further includes calculating a trace approximation of the adjacency matrix based on the determined diagonal random matrix and the selected subset of entries and storing the calculated trace approximation of the adjacency matrix. By selecting the subset of entries from the matrix-vector product and by performing the iterative calculations in parallel, the computational power and the storage requirements may be reduced. This may enable efficient processing of adjacency matrices with huge dimensions for calculating the corresponding trace estimations. Due to parallel processing of limited set of entries, the disclosed method may calculate the randomized trace of the adjacency matrix quickly and efficiently.

In other embodiments, the method further includes comparing the computational power of the system with a pre-determined computational power threshold. The method further includes determining at least one trigger point based on the comparison. Therefore, even if the computational power of the system is less than the pre-determined computational power threshold, the disclosed method may be executed seamlessly on the system. Whereas the traditional methods may not be executed on the systems whose computational power is less than the pre-determined computational power threshold. As a result, the disclosed method may be executed on low-end systems with low computational power.

According to an aspect of the present disclosure, there is provided a computer-implemented method for calculating a trace approximation of an adjacency matrix. The computer-implemented method includes retrieving, by a computer, an adjacency matrix associated with a complex graph. The retrieved adjacency matrix may be of a first dimension. The computer-implemented method further includes determining at least one trigger point based on at least one of a computational power of the computer or detection of one or more faults associated with one or more calculations performed by the computer. The computer-implemented method further includes determining, by the computer, a random vector based on the retrieved adjacency matrix and the determined at least one trigger point. The random vector may have an expectation value of zero. The computer-implemented method further includes generating, by the computer, a matrix-vector based on the retrieved adjacency matrix and the determined random vector. The computer-implemented method further includes determining, by the computer, a first set of natural numbers based on the first dimension of the retrieved adjacency matrix. The count of elements in the determined first set of natural numbers may be less than the first dimension of the retrieved adjacency matrix. The computer-implemented method further includes selecting, by the computer, a subset of entries from the generated matrix-vector based on the determined first set of natural numbers. The computer-implemented method further includes determining, by the computer, a diagonal random matrix based on a summation of canonical outer products formed by the selected subset of entries. The computer-implemented method further includes calculating, by the computer, a trace approximation of the adjacency matrix based on the determined diagonal random matrix and the selected subset of entries and storing, by the computer, the calculated trace approximation of the adjacency matrix. By selecting a subset of entries from the matrix-vector product and by performing the iterative calculations in parallel, the computational power and the storage requirements may be reduced. This may enable efficient processing of adjacency matrices with huge dimensions for calculating the corresponding trace estimations. Due to parallel processing of limited set of entries, the disclosed computer-implemented method may calculate the randomized trace of the adjacency matrix quickly and efficiently.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

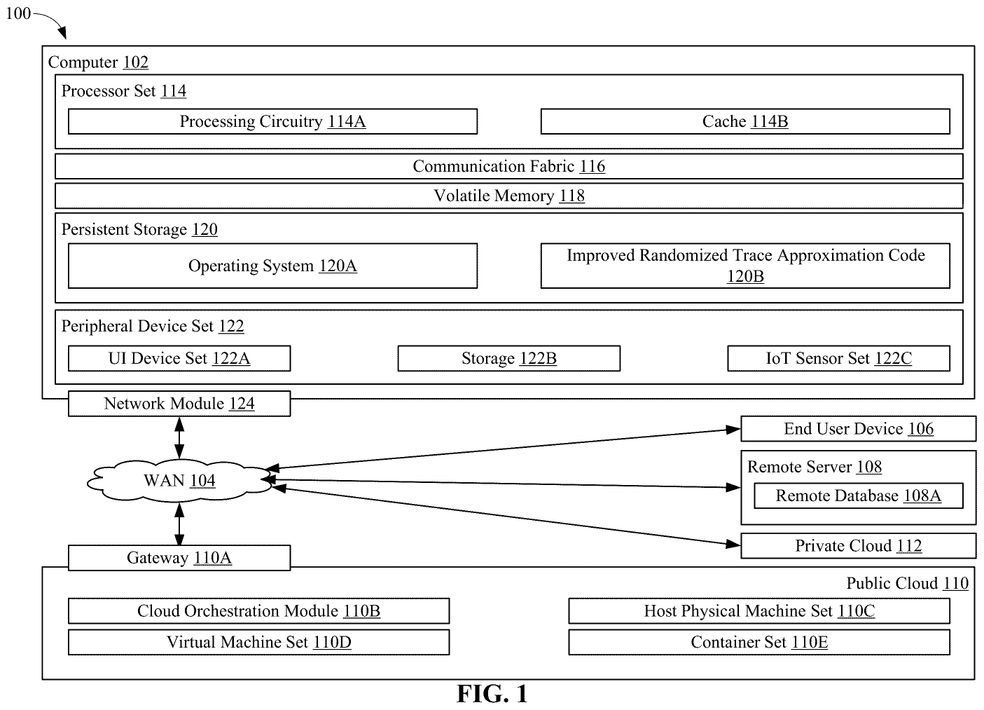

FIG. 1 is a diagram that illustrates a computing environment for randomized trace approximation calculation based on asynchronous computing architecture, in accordance with an embodiment of the disclosure. With reference to FIG. 1, there is shown a computing environment 100 that contains an example of an environment for the execution of at least some of the computer code involved in performing the inventive methods, such as an improved randomized trace approximation code 120B. In addition to block 120B, computing environment 100 includes, for example, a computer 102, a wide area network (WAN) 104, an end-user device (EUD) 106, a remote server 108, a public cloud 110, and a private cloud 112. In this embodiment, the computer 102 includes a processor set 114 (including a processing circuitry 114A and a cache 114B), a communication fabric 116, a volatile memory 118, a persistent storage 120 (including an operating system 120A and a block 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future that is capable of running a program, accessing a network or querying a database, such as a remote database 130. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 114B and the other storage media discussed below. The program instructions, and associated data, are accessed by the processor set 114 to control and direct performance of the inventive methods. In computing environment 100, at least some of the instructions for performing the inventive methods may be stored in the block 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

The Volatile Memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in block 120B typically includes at least some of the computer code involved in performing the inventive methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments, storage 122B may take the form of a quantum computing storage device for storing data in the form of qubits. In embodiments where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer and another sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments, network control functions, and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The End User Device (EUD) 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present, the recommendation to an end user. In some embodiments, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 130 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

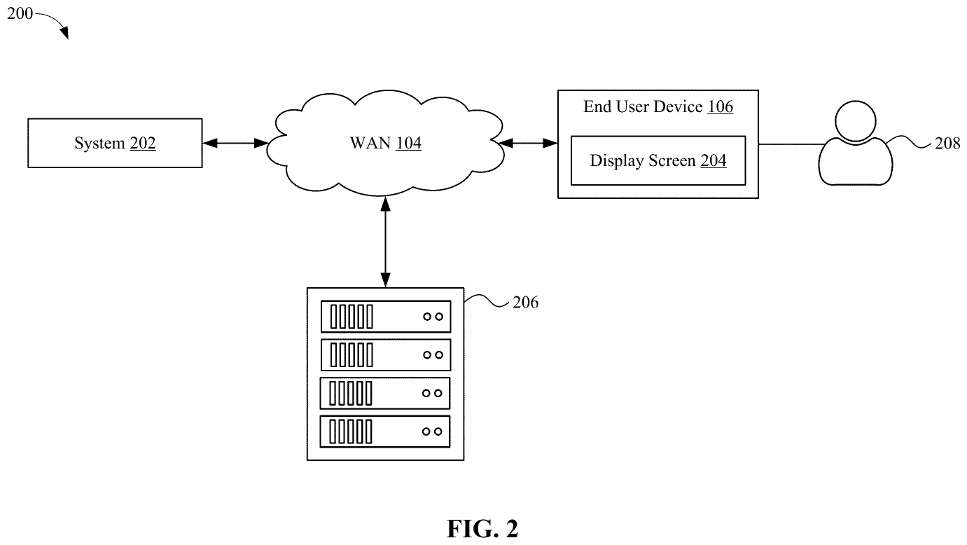

FIG. 2 is a diagram that illustrates an environment for randomized trace approximation calculation based on asynchronous computing architecture, in accordance with an embodiment of the disclosure. FIG. 2 is explained in conjunction with elements from FIG. 1. With reference to FIG. 2, there is shown a diagram of a network environment 200. The network environment 200 includes a system 202, a display screen 204, a server 206, and a user 208, The network environment 200 may further include the EUD 106, and the WAN 104 of FIG. 1. In an embodiment, the system 202 may be an exemplary embodiment of the computer 102 of FIG. 1.

The system 202 may include suitable logic, circuitry, interfaces, and/or code that may be configured to calculate a trace approximation of an adjacency matrix. The system 202 may be configured to retrieve the adjacency matrix associated with a complex graph and further determine a random vector based on the retrieved adjacency matrix. The system 202 may be further configured to generate a matrix vector based on the retrieved adjacency matrix and the determined random vector. The system 202 may be further configured to determine a first set of natural numbers based on the first dimension of the retrieved adjacency matrix. The system 202 may be further configured to select a subset of entries from the generated matrix-vector based on the determined first set of natural numbers and determine a diagonal random matrix based on a summation of canonical outer products formed by the selected subset of entries. The system 202 may be further configured to calculate a trace approximation of the adjacency matrix based on the determined diagonal random matrix and the selected subset of entries and store the calculated trace approximation of the adjacency matrix. Examples of the system 202 may include, but are not limited to, a computing device, a virtual computing device, a mainframe machine, a server, a computer workstation, a smartphone, a cellular phone, a mobile phone, a gaming device, a consumer electronic (CE) device and/or any other device with trace calculation capabilities.

The EUD 106 may include suitable logic, circuitry, interfaces, and/or code that may provide the adjacency matrix, as a user input, to the system 202. In another embodiment, the EUD 106 may be configured to output the calculated trace approximation of the adjacency matrix on the display screen 204. Specifically, the system 202 may control the display screen 204 of the EUD 106 to display the calculated trace approximation of the adjacency matrix on the display screen 204. The EUD 106 may be associated with the user 208 who might wish to calculate the trace approximation of the adjacency matrix or who might wish to generate a solution of a graph analysis problem. Examples of the EUD 106 may include, but are not limited to, a computing device, a mainframe machine, a server, a computer workstation, a smartphone, a cellular phone, a mobile phone, a gaming device, a consumer electronic (CE) device and/or any other device with trace calculation capabilities.

The display screen 204 may comprise suitable logic, circuitry, and interfaces that may be configured to display the calculated trace approximation or the solution of the graph analysis problem. In an embodiment, the display screen 204 may further display one or more user interface elements from which the user 208 may be able to provide the user inputs. In some embodiments, the display screen 204 may be an external display device associated with the EUD 106. The display screen 204 may be a touch screen which may enable the user to provide the user input via the display screen 204. The touch screen may be at least one of a resistive touch screen, a capacitive touch screen, or a thermal touch screen. The display screen 204 may be realized through several known technologies such as, but are not limited to, at least one of a Liquid Crystal Display (LCD) display, a Light Emitting Diode (LED) display, a plasma display, or an Organic LED (OLED) display technology, or other display devices. In accordance with an embodiment, the display screen 204 may refer to a display screen of a head-mounted device (HMD), a smart-glass device, a see-through display, a projection-based display, an electro-chromic display, or a transparent display.

The server 206 may include suitable logic, circuitry, and interfaces, and/or code that may be configured to store the adjacency matrix, and the random vector. The server 206 may be further configured to store the generated matrix-vector, the determined first set of natural numbers, the selected subset of entries, the determined random diagonal matrix, and the calculated trace approximation of the adjacency matrix. The server 206 may be implemented as a cloud server and may execute operations through web applications, cloud applications, HTTP requests, repository operations, file transfer, and the like. Other example implementations of the server 206 may include, but are not limited to, a database server, a file server, a web server, a media server, an application server, a mainframe server, or a cloud computing server.

In at least one embodiment, the server 206 may be implemented as a plurality of distributed cloud-based resources by use of several technologies that are well known to those ordinarily skilled in the art. A person with ordinary skill in the art will understand that the scope of the disclosure may not be limited to the implementation of the server 206 and the system 202 as two separate entities. In certain embodiments, the functionalities of the server 206 can be incorporated in its entirety or at least partially in the system 202 or vice-versa, without a departure from the scope of the disclosure.

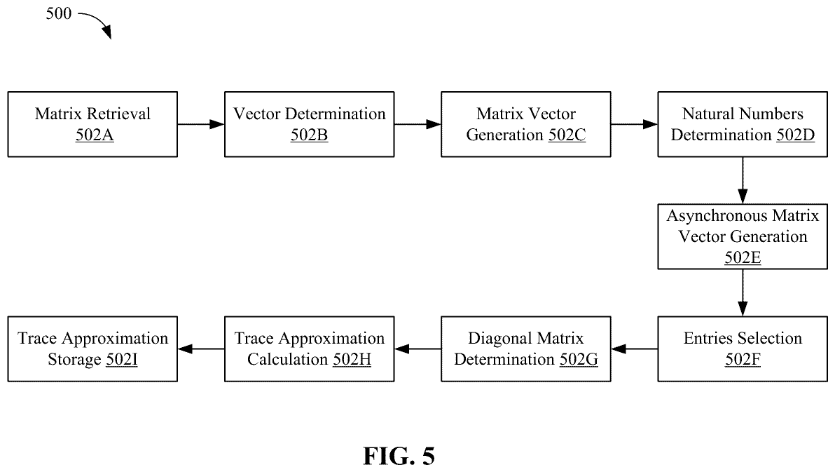

In operation, the user 208 may wish to solve the graph analysis problem. The graph analysis problem may correspond to a category of computational problems that may involve studying and drawing insights from graphs, which may be mathematical structures consisting of a set of nodes (vertices) and a set of edges (connections) that link the set of nodes. In an embodiment, the graph analysis problem may be associated with real-world problems. Specifically, the graph analysis problems may be linked to the real-world problems because the graph analysis problems may provide a powerful framework for modeling, understanding, and solving complex issues that may involve relationships, connections, and interactions among entities. Details about the graph analysis problem are provided, for example, in FIG. 5.

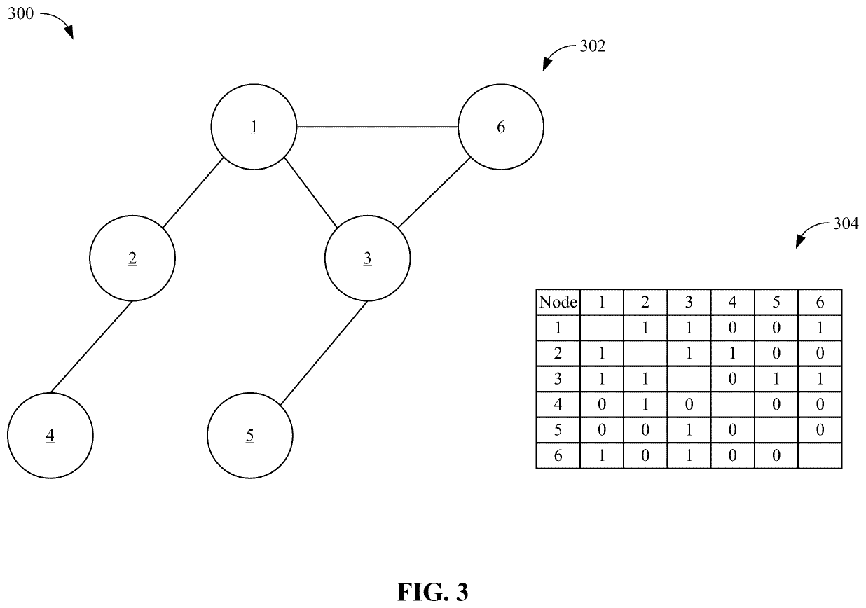

In an embodiment, the graph analysis problem may include an analysis of complex graphs that may include the set of nodes and the set of edges (or links) between the plurality of nodes. The graph may be represented as the adjacency matrix. The adjacency matrix may be a square matrix that may represent the connections or relationships between nodes (or vertices) in the complex graph. Each entry in the adjacency matrix may correspond to a potential edge between two nodes, and its value indicates whether there is a connection between those nodes or not. Typically, in the complex graph, the adjacency matrix may be symmetric, with a “1” in the entry (I, j) if nodes i and j are connected and a “0” if not connected. Hence, the adjacency matrix may provide a structured way to encode the graph's connectivity and may be a fundamental tool for performing one or more graph-related computations and algorithms, making it essential in various graph analysis problems, from social network analysis to transportation route optimization and beyond. Details about the graphs and adjacency matrix are provided, for example, in FIG. 3.

The system 202 may be configured to retrieve the adjacency matrix associated with the complex graph. The retrieved adjacency matrix is of a first dimension (for example N×N). Based on the retrieved adjacency matrix, the system 202 may be configured to determine the random vector. The random vector may have an expectation value of zero (0) and a variance of one (1). The system 202 may be configured to generate a matrix vector based on the retrieved adjacency matrix and the determined random vector. The matrix vector may correspond to a multiplication of the retrieved adjacency matrix, and the determined random vector. Details about the matrix vector are provided, for example, in FIG. 5.

The system 202 may be further configured to determine a first set of natural numbers based on the first dimension of the retrieved adjacency matrix. In an embodiment, a count of elements in the determined first set of natural numbers may be less than the first dimension of the retrieved adjacency matrix. The system 202 may be further configured to select a diagonal random matrix based on a summation of canonical outer products formed by the selected subset of entries.

Based on the determined diagonal random matrix and the selected subset of entries, the system 202 may be configured to calculate a trace approximation of the adjacency matrix. The system 202 may be further configured to store the calculated trace approximation of the adjacency matrix in the volatile memory 118. In another embodiment, the system 202 may be further configured to transmit the calculated trace approximation to the EUD 106 for rendering the calculated trace approximation on a user interface of the display screen 204.

FIG. 3 depicts an exemplary complex graph and an exemplary adjacency matrix associated with the exemplary complex graph, in accordance with an embodiment of the disclosure. FIG. 3 is explained in conjunction with elements from FIG. 1 and FIG. 2. With reference to FIG. 3, there is shown an exemplary diagram 300 that includes a complex graph 302 and an adjacency matrix 304 associated with the complex graph 302.

The complex graph 302 may be a non-linear data structure that may include a set of vertices and a set of edges. The set of vertices may also be referred to as a set of nodes. Each of the set of edges may correspond to a line or an arc that may connect any two nodes in the complex graph 302. More formally, the complex graph 302 may be composed of the set of vertices or nodes (V) and the set of edges (E) and may be denoted by G (E, V).

As discussed above, the complex graph 302 may be associated with a graph analysis problem. The graph analysis problem may refer to a broad category of computational problems that may involve a study, an exploration, and a manipulation of the complex graph 302. Examples of the complex graph 302 may correspond to a graph related to, but are not limited to, a graph traversal problem, a network routing problem, a social network analysis problem, a protein folding problem, a graph centrality problem, a sorting problem, or a graph classification problem.

In an exemplary embodiment, the graph traversal problem may be a fundamental problem that may involve visiting all the nodes (vertices) of the complex graph 302 in a systematic way to explore or search for specific information or patterns within the complex graph 302. In the real world, if there is a map of a city with streets represented as a graph, then each intersection may be represented by a vertex, and each road between the intersections may be represented by an edge. It may be required to find a shortest path from a current location of a user to a specific destination within the city. This problem may be solved using graph traversal, where the user may start at a current intersection and use one or more traversal techniques to explore the network of streets, finding the shortest route to the destination.

As depicted in FIG. 3, the complex graph 302 may include six (6) vertices or nodes {1, 2, 3, 4, 5, and 6}. In other scenarios, the graph data structure can include a different number of vertices from what is depicted. Additionally, the set of vertices of the complex graph 302 can be connected differently from what is depicted.

The complex graph 302 may be associated with the adjacency matrix 304. Specifically, the complex graph 302 may also be represented by the adjacency matrix 304. The adjacency matrix 304 may be a square matrix that may be used to represent the complex graph 302. In adjacency matrix 304, each row and column corresponds to a vertex (or node) in the complex graph 302, and the entries of the adjacency matrix 304 may indicate whether there is an edge (or a connection) between the vertices.

Let G (E,V) be the complex graph 302, then the adjacency matrix (A) 304 of the complex graph (G) 302 may be an N×N matrix that may have a ‘1’ in the (i, j)-position (or cell) if there exists an edge from i^{th} vertex to the j^{th} vertex and a ‘0’ in the (i, j)-position otherwise. Mathematically, the adjacency matrix (A) 304 A∈{0,1}^{N×N} may be represented by equation (1) as follows:

$${A}_{i j} = \{ \begin{matrix}1 , & if i , j ∈ E \\ 0 , & otherwise\end{matrix} \qquad ( 1 )$$

As depicted in FIG. 3, the value of the cell (1,2) and the cell (2,1) may be ‘1’ because an edge is present between the vertex {1}, and the vertex {2} of the complex graph 302. Similarly, the value of the cell (1,5) and the cell (5,1) may be ‘0’ in the adjacency matrix 304 because no edge is present between the vertex {1}, and vertex {5} of the complex graph 302.

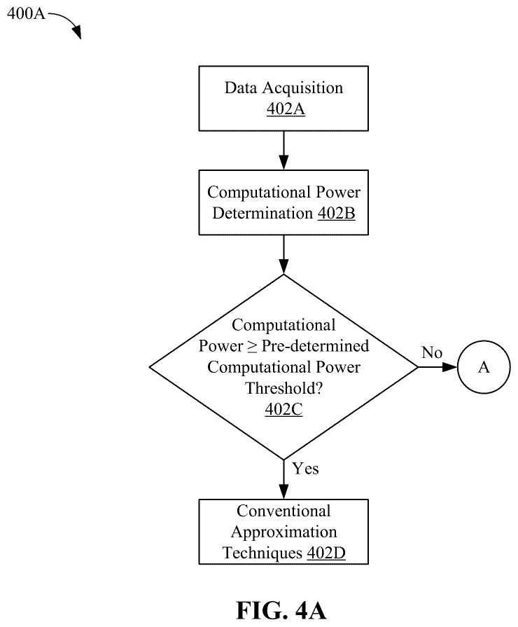

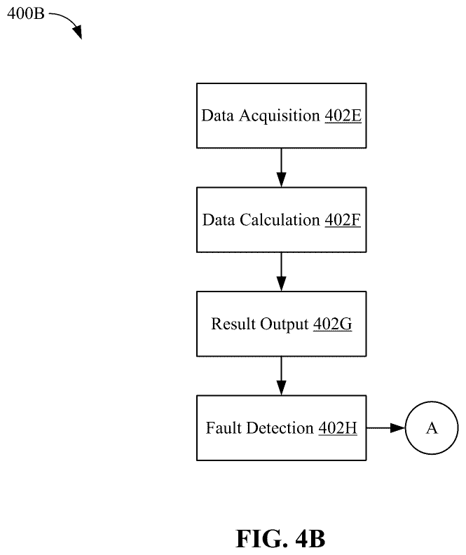

FIG. 4A is a diagram that illustrates exemplary operations for determination of computational power of an underlying electronic device, in accordance with an embodiment of the disclosure. FIG. 4A is explained in conjunction with elements from FIG. 1, FIG. 2, and FIG. 3. With reference to FIG. 4A, there is shown a block diagram 400A that illustrates exemplary operations from 402A to 402D, as described herein. The exemplary operations illustrated in the block diagram 400 may start at 402A and may be performed by any computing system, apparatus, or device, such as by the computer 102 of FIG. 1 or system 202 of FIG. 2. Although illustrated with discrete blocks, the exemplary operations associated with one or more blocks of the block diagram 400 may be divided into additional blocks, combined into fewer blocks, or eliminated, depending on the particular implementation.

At 402A, a data acquisition operation may be performed. In the data acquisition operation, the system 202 may be configured to acquire information associated with an underlying system or an electronic device (such as the computer 102) on which the operations for randomized trace approximation calculation may have to be performed. In case the system 202 corresponds to an on-premise system, then the system 202 may be configured to acquire data associated with the on-premise system. In another embodiment, if the system 202 corresponds to a cloud system, then the system 202 may be configured to acquire data associated with the underlying electronic device on which the operations for the randomized trace approximation may be implemented.

The acquired information may include, but not limited to, processor information, and memory information associated with the underlying system or the electronic device. Specifically, the processor information may include information associated with at least one of a clock speed (clock frequency), a number of cores, a graphics processing unit (GPU), a thermal design power (TDP), and a parallel computing capability associated with one or more processor of the underlying system/electronic device. The memory information may include a cache size, a memory (RAM) capacity and speed, storage type and speed, and the like associated with the memory of the underlying system or the electronic device.

At 402B, a computational power determination operation may be performed. In the computational power determination operation, the system 202 may be configured to determine a computational power of the underlying system or the electronic device based on the acquired information. The computational power of the underlying system or the electronic device may correspond to a measure of an ability of the underlying system or electronic device to perform computations, process data, and execute tasks within a given timeframe. Details about the computational power are known in the art and therefore, have been omitted for the sake of brevity.

At 402C, the determined computational power of the underlying system or the electronic device may be compared with a pre-determined computational power threshold. In case the determined computational power of the underlying system or the electronic device is greater than the pre-determined computational power threshold, then conventional trace approximation techniques 402D may be executed to estimate the trace of the adjacency matrix. Such conventional trace approximation techniques are known in the art.

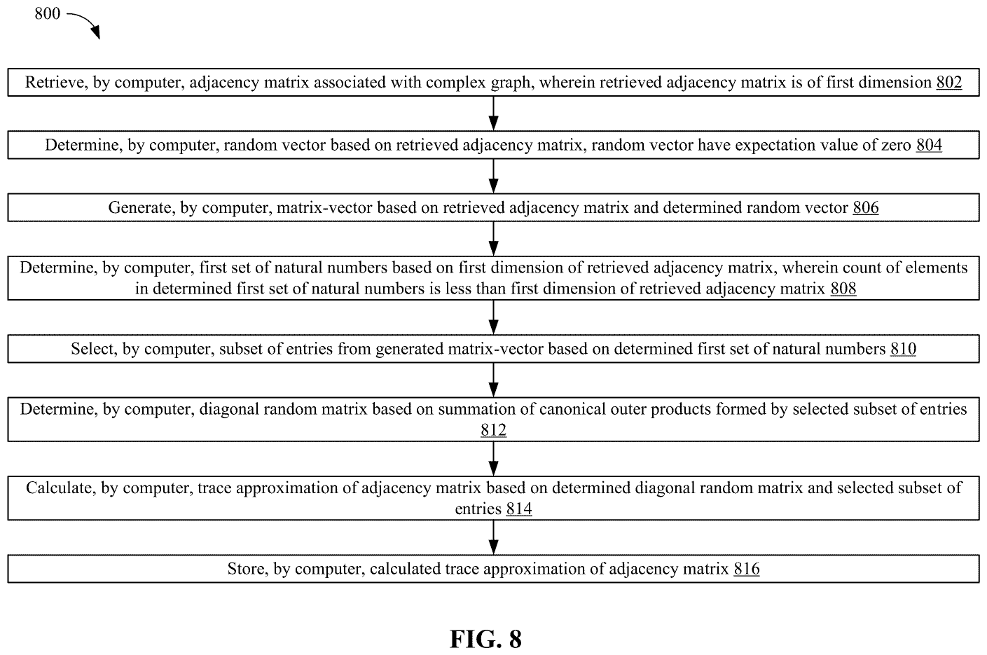

In case the determined computational power of the underlying system or the electronic device is less than the pre-determined computational power threshold, then the operations described in FIG. 5 or FIG. 8 may be executed to calculate the trace approximation. In some embodiment, the operations described at FIG. 5 or FIG. 8 may be executed to calculate the trace approximation even if the determined computational power of the underlying system or the electronic device is greater than the pre-determined computational power threshold.

FIG. 4B is a diagram that illustrates exemplary operations for determination of one or more faults associated with one or more calculations performed by at least one electronic device, in accordance with an embodiment of the disclosure. FIG. 4B is explained in conjunction with elements from FIG. 1, FIG. 2, FIG. 3, and FIG. 4A. With reference to FIG. 4B, there is shown a block diagram 400B that illustrates exemplary operations from 402E to 402H, as described herein. The exemplary operations illustrated in the block diagram 400B may start at 402E and may be performed by any computing system, apparatus, or device, such as by the computer 102 of FIG. 1 or system 202 of FIG. 2. Although illustrated with discrete blocks, the exemplary operations associated with one or more blocks of the block diagram 400B may be divided into additional blocks, combined into fewer blocks, or eliminated, depending on the particular implementation.

In an embodiment, Randomized trace estimation requires that the matrix-vector (MV) product to be completed without any error. However, the underlying system of the electronic device with large numbers of processors may introduce several faults. As an example, in High-Performance Computing (HPC) applications, with tens of thousands of nodes, resilience becomes a big challenge. Even if each node provides an individual MTBF (Mean Time Between Failures) of, say, one century, a machine with 100,000 such nodes may encounter a failure every 9 hours on average, which may be larger than the execution time of many HPC applications. In case of a machine with 1,000,000 nodes (also with a one-century MTBF) will encounter a failure every 53 minutes on average. Therefore, there is a requirement to detect faults that can be introduced in the underlying system. In case the underlying system or the electronic device has faults, the disclosed method for calculating the trace may be applied as the disclosed method may execute quickly as the disclosed method discards set of the entries of the matrix vector due to assumed faults.

At 402E, a data acquisition operation may be executed for one or more calculations. In the data acquisition operation, the system 202 may be configured to acquire data on which one or more calculations may have to be performed. In another embodiment, the acquired data may correspond to any data in any format on which one or more calculations may be performed by the underlying system or the electronic device. By way of a first example and not limitation, the acquired data may correspond to any matrix (or the complex matrix) on which the one or more calculations may be performed by the underlying system or the electronic device.

At 402F, a calculation operation may be executed. In the calculation operation, the system 202 may be configured to apply one or more mathematical operations (or calculations) on the acquired data. With reference to the first example, the one or more mathematical operations may correspond to a matrix multiplication operation, a matrix decomposition operation, the matrix rank calculation operation, a matrix norm identification operation, and the like. As a second example, the one or more mathematical operations may correspond to the matrix rank calculation operation.

At 402G, a result output operation may be executed. In the result output operation, the system 202 may be configured to output a result generated by the application of the one or more mathematical operations on the acquired data. As per the second example, the result output operation may output the calculated rank of the matrix included in the acquired data.

At 402G, a fault detection operation may be executed. In the fault detection operation, the system 202 may be configured to compare the generated result with a ground truth. The ground truth may correspond to a real value and an absolute value of the rank of the matrix that may be used as a reference for detecting one or more faults associated with the one or more calculations performed by the underlying system or the electronic device. In case the result generated by the underlying system, or the electronic device is the same as the ground truth, then the conventional trace approximation operations 404D may be executed. Otherwise, if the generated result is different from the ground truth, then one or more faults are present in the underlying system, or the electronic device and the operations described at FIG. 5 or FIG. 8 may be executed to calculate the trace approximation. In some embodiment, the operations described at FIG. 5 or FIG. 8 may be executed to calculate the trace approximation even if the result generated by the underlying system, or the electronic device, is the same as the ground truth.

It may be noted that the calculation of the rank of the matrix is provided just as an example of the one or more calculations. The disclosure is not limited to the calculation of the rank to detect the one or more faults in the underlying system or the electronic device. For example, the system 202 may utilize other techniques such as, but not limited to, row checksums to detect the one or more faults.

FIG. 5 is a diagram that illustrates exemplary operations for randomized trace approximation calculation based on asynchronous computing architecture, in accordance with an embodiment of the disclosure. FIG. 5 is explained in conjunction with elements from FIG. 1, FIG. 2, FIG. 3, FIG. 4A, and FIG. 4B. With reference to FIG. 5, there is shown a block diagram 500 that illustrates exemplary operations from 502A to 5021, as described herein. The exemplary operations illustrated in the block diagram 500 may start at 502A and may be performed by any computing system, apparatus, or device, such as by the computer 102 of FIG. 1 or the system 202 of FIG. 2. Although illustrated with discrete blocks, the exemplary operations associated with one or more blocks of the block diagram 500 may be divided into additional blocks, combined into fewer blocks, or eliminated, depending on the particular implementation.

At 502A, a matrix retrieval operation may be executed. In the matrix retrieval operation, the system 202 may be configured to retrieve an adjacency matrix (A). The adjacency matrix (A) may be associated with a complex graph and may be of a first dimension. Specifically, the adjacency matrix (A) may be a square matrix of dimension (N×X), where N may correspond to a number of rows and a number of columns of the adjacency matrix (A). Specifically, the adjacency matrix (A) may have N rows and N columns.

In an embodiment, the dimension of the adjacency matrix (A) may be based on a number of vertices of the corresponding complex graph. Specifically, the number of rows and the number of columns in the adjacency matrix (A) may be equal to the number of vertices of the complex graph associated with the adjacency matrix (A). As discussed above, the complex graph may be associated with a graph analysis problem that may represent a real-world problem. Examples of the graph analysis problem may include, but are not limited to, a graph traversal problem, a network routing problem, a social network analysis problem, a protein folding problem, a graph centrality problem, a sorting problem, or a graph classification problem. Details about the graph analysis problem are provided, for example, in FIG. 3.

Typically, the adjacency matrix (A) may be mathematically represented by equation (2) as follows:

$$A = f ( G ) \qquad ( 2 )$$

where
G is the graph analysis problem-dependent matrix and G∈ [symbol] ^{N×N}
f(.) is a real-valued or complex valued function, and
N corresponds to a set of natural numbers.

In an alternate embodiment, the system 202 may receive data associated with the graph analysis problem. The system 202 may be further configured to generate the complex graph associated with the graph analysis problem based on the received data. The system 202 may further generate the adjacency matrix (A) based on the generated complex graph. Details about the complex graph and the adjacency matrix (A) are provided, for example, in FIG. 3.

At 502B, a vector determination operation may be performed. In the vector determination operation, the system 202 may be configured to determine a random vector (x) based on the retrieved adjacency matrix. The random vector (x) may be a collection of random variables that are statistically independent and identically distributed with a mean (or an expected value) of 0 and a variance of 1. The expected value of the random variable may correspond to a measure of its average or central value when considering many samples from the underlying probability distribution. In other words, each component of the random vector (x) may follow a similar probability distribution, and on average, these components sum up to zero, while their spread or dispersion is standardized to a variance of 1.

In an embodiment, the random vector (x) may be sampled based on a Rademacher distribution. Specifically, the values of the components of the one or more random vector (x) may be based on the Rademacher distribution. The Rademacher distribution may be a discrete probability distribution that takes on the values +1 and −1 with equal probability. In the context of the random vector (x) sampled from the Rademacher distribution, each component of the random vector (x) may be an independent random variable following the Rademacher distribution. In an alternative embodiment, the random vector (x) may be sampled based on a Gaussian distribution. Details about the Gaussian distribution is known in the art and therefore, have been omitted for the sake of brevity.

Typically, the random vector (x) may be mathematically represented by equation (3) as follows:

$$x = [ {x}_{1} , {x}_{2} , {x}_{3} , … . . {x}_{k} ] \qquad ( 3 )$$

where
x is the random vector and x∈ [symbol] ^{N}, and
x₁, x₂, x₃, . . . xₖ are ‘k’ components of the random vector x, and k≤N and
N corresponds to a universal set of natural numbers.

In an embodiment, the mean of the random vector may be a vector summarizes the central tendency of the components of the random vector. It is also known as the expected value of the random vector. Mathematically, the mean (μ) of the random vector may be defined by equation (4) as follows:

$$μ = [ E ( {x}_{1} ) , E ( {x}_{2} ) , E ( {x}_{3} ) , … . . E ( {x}_{k} ) ] \qquad ( 4 )$$

where
μ corresponds to the mean of the random vector x, and
E(xᵢ) corresponds to the expected value of the i^{th} component of the random vector x.

The variance of the random vector x may provide a measure of a spread or a dispersion of the components of the random vector x. In an embodiment, the variance (E) of the random vector (x) may be defined as a matrix, often called the covariance matrix. The elements of this matrix, Σᵢⱼ, represent the covariances between the components xᵢ and xⱼ. The variance of the random vector x may provide information about how the components of the random vector x are related to each other, with diagonal elements giving the spread of each component and off-diagonal elements representing the relationships between components.

At 502C, a matrix vector generation operation may be performed. In the matrix vector generation operation, the system 202 may be configured to generate a matrix-vector (Ax). The matrix-vector (Ax) may be generated based on a multiplication of the adjacency matrix (A) with the random vector (x). Based on the multiplication of the adjacency matrix (A) with the random vector (x), a new vector (MV) may be generated. Details about the multiplication of the adjacency matrix (A) and the random vector (x) are known in the art and therefore have been omitted of the sake of brevity.

At 502D, a natural numbers determination operation may be performed. In the natural numbers determination operation, the system 202 may be configured to determine a first set of natural numbers (T) based on the first dimension of the retrieved adjacency matrix (A). In an embodiment, the first set of natural numbers (T) may be determined from a set of natural numbers (T) whose elements belong to the universal set of natural numbers (i.e. T∈N). In an embodiment, the set of natural numbers (T) may include all natural numbers {1, 2, 3, . . . N}. In an embodiment, the system 202 may be configured to randomly select one or more natural numbers, from the set of natural numbers (T), to be included in the first set of natural numbers (τ). In an embodiment, a probability of selection of each natural number, from the set of natural numbers (T), may be equal. Therefore, each natural number may have equal possibility of representation in the first set of natural numbers (ξ).

Mathematically, given the universal set of natural numbers (T∈N), the system 202 may select any T≡|τ| natural numbers of {1, 2, 3, . . . N} with equal probability, i.e. each of the

$$( \begin{matrix}N \\ T\end{matrix} )$$

possible row sets of the adjacency matrix (A) is picked with probability

$${( \begin{matrix}N \\ T\end{matrix} )}^{- 1} .$$

At 502E, an asynchronous matrix vector generation operation may be performed. In the asynchronous matrix vector generation operation, the system 202 may be configured to generate an asynchronous matrix vector (y). The asynchronous matrix vector (y) may be generated based on the matrix vector generated at 502C and the first set of natural numbers (τ). Specifically, the asynchronous matrix vector (y) may be defined as a function of the first set of natural numbers (τ). The asynchronous matrix vector (y) may be mathematically represented by equation (5) as follows:

$$y = A {\vert}_{} x \qquad ( 5 )$$

where
y is the asynchronous matrix vector,
A is adjacency matrix,
x is the random vector, and
   |_{τ} is an operator equivalent to the regular MV Ax with the exception that the i^{th} row of the adjacency matrix (A) is now replaced by an N-length zero row vector for any i∉τ.

In an embodiment, the system 202 may be configured to generate the asynchronous matrix-vector (y) based on the retrieved adjacency matrix (A), the determined random vector (x), and the first set of natural numbers (T), wherein at least one row of the retrieved adjacency matrix is updated by a zero-row vector in the generated matrix-vector (y) based on a determination of an absence of a corresponding row number associated with the at least one row of an initial matrix-vector from the first set of natural numbers (T).

As discussed above, the asynchronous matrix vector (y) may be defined as the function of the first set of natural numbers (τ). In such a case, the asynchronous matrix vector (y) may be mathematically represented by equation (6) as follows:

$${e}_{i}^{T} y = \{ \begin{matrix}{[ Ax ]}_{i} , & if i ∈ \\ 0 , & if i ∉\end{matrix} \qquad ( 6 )$$

where
e is an identity matrix and e∈{0,1}^{N};
eᵢ corresponds to i^{th} column of the N×N identity matrix e;
eᵢ^{T} corresponds to a transpose of the i^{th} column of the N×N identity matrix e,
y is the asynchronous matrix vector,
A is adjacency matrix,
x is the random vector, and
[Ax]ᵢ corresponds to a value of the i^{th} column (or component) of the matrix vector generated at 502C.

The use of an asynchronous architecture provides an efficient and effective calculation of the trace approximation. Typically, the asynchronous computations may arise naturally in distributed-memory implementations for the computation of stationary points via iterative algorithms so as to reduce idle time between different processing elements via reducing synchronization points.

At 502F, an entries selection operation may be performed. In the entries selection operation, the system 202 may be configured to select a subset of entries from the generated asynchronous matrix vector (y). The selection of the subset of entries may be based on the determined first set of natural numbers. Specifically, the system 202 may be configured to select the subset of entries from the asynchronous matrix vector (y) based on a count of the first set of natural numbers. By way of example, in case the count of the first set of natural numbers is 6, the system 202 may be configured to randomly select 6 entries from generated asynchronous matrix vector (y). The system 202 may discard the leftover entries due to assumed one or more faults that may be indicated by the corresponding row checksums. In another embodiment, the selection of the entries may be based on the computational power of the underlying system or the electronic device. In another embodiment, the selection of the entries may be based on a count of a set of load balancers associated with the underlying system (say a sever). For example, in a scenario of load-balancing in high-performance computing clusters with ‘N’ identical processing elements connected through some medium where each row of the adjacency matrix (A) is distributed without an overlap to a separate processing element. Since different rows of the adjacency matrix ‘A’ may have different sparsity patterns, waiting for all processing elements to synchronize may lead to a poor throughput. Instead, the system 202 may sample each product Aₓ_{ₖ} at fixed intervals of time and only consider the finalized entries.

At 502G, a diagonal matrix determination operation may be performed. In the diagonal matrix determination operation, the system 202 may be configured to determine a diagonal random matrix (D_{τ}). The diagonal random matrix may be a square matrix in which all the elements outside the main diagonal (from the top-left to the bottom-right) may be zero. Furthermore, the elements of the main diagonal may be random values that may follow a particular probability distribution (say a Gaussian Distribution). The diagonal random matrix (D_{τ}) may be mathematically represented by equation (7) as follows:

$$( 7 )$$

where
D_{T} is the diagonal random matrix,
eᵢ is i^{th} row of the identity matrix e,
eᵢ^{T} is the i^{th} row transpose of the identity matrix e, and
τ corresponds to the first set of natural numbers.

At 502H, a trace approximation calculation operation may be performed. In the trace approximation calculation operation, the system 202 may be configured to calculate a trace approximation of the adjacency matrix (A) based on the determined diagonal random matrix (D_{τ}) and the selected subset of entries. As discussed above, the trace of the adjacency matrix (A) may be a mathematical operation that may yields a scalar value. It may be defined as the sum of the elements along the main diagonal of the adjacency matrix (A), which runs from the top-left to the bottom-right of the adjacency matrix (A).

Let k=1, 2, . . . , m, m∈N, and denote by Tₖ a random subset of |τₖ|∈N integers (without replacement) from 1 to N. The deterministic integer |τₖ| may be an instance of the integer-valued random variable T∈{1, 2 . . . , N}. Then, for any N-length instances x₁, x₂, . . . , xₘ, of a random vector x, the asynchronous randomized trace estimator may be mathematically represented by equation (7) as follows:

$${m}_{} = \frac{1}{m} {\sum }_{k = 1}^{m} {x}_{k}^{T} ( A {\vert}_{{k}_{}} {x}_{k} ) = \frac{1}{m} {\sum }_{k = 1}^{m} {{[ {x}_{k} ]}_{i}^{T} [ A {\vert}_{{k}_{}} {x}_{k} ]}_{i} \qquad ( 7 )$$

where
τₘ is the diagonal random matrix,
m corresponds to a number of instances of the random vector x,
xₖ^{T} is the transpose of the kl instance of the random vector x,
A|_{τ}_{ₖ} corresponds to the asynchronous matrix vector y, and
A corresponds to the adjacency matrix.

In equation (7), the second equality of τₘ follows by recalling that the i^{th} entry of the product A|_{τ}_{ₖ}xₖ if and only if i∈τₖ.

In case when T≡N, as in the synchronous case, the matrix D_{T} may be equal to the N×N identity matrix. The asynchronous randomized trace estimator may be mathematically represented by equation (8) as follows:

$${m}_{} = \frac{1}{m} {\sum }_{k = 1}^{m} {x}_{k}^{T} {D}_{{k}_{}} A {x}_{k} = \frac{1}{m} {\sum }_{k = 1}^{m} {x}_{k}^{T} Q ( {k}_{} ) {x}_{k} \qquad ( 8 )$$

where
τₘ is the diagonal random matrix,
m corresponds to a number of instances of the random vector x,
xₖ^{T} is the transpose of the k^{th} instance of the random vector x,
D_{τ}_{ₖ} is the k^{th} instance of the diagonal random matrix, and
A corresponds to the adjacency matrix,

$$Q ( {k}_{} ) = A and Ax = A x$$

In an embodiment, the system 202 may be configured to iteratively select the subset of entries from the generated asynchronous matrix-vector based on the determined first set of natural numbers. Based on the selected subset of entries, the system 202 may be configured to determine the diagonal random matrix based on the summation of the canonical outer products formed by the corresponding subset of entries. Based on the selected subset of entries and the determined diagonal random matrix, the system 202 may be configured to calculate the trace approximation of the adjacency matrix (A). Specifically, the system 202 may be configured to calculate the trace approximation of the adjacency matrix (A) based on an average of a set of intermediate results obtained based on the iterative selection of the subset of entries and the iterative determination of the diagonal random matrix. In an embodiment, the number of times this iteration is done may be dependent on a number of combinations (n_{c}_{ᵣ}) that may be formed by the selected set of natural numbers. The calculated trace approximation during each iteration (i.e., the intermediate result) may be captured and stored in the memory. The system 202 may be further configured to average the calculated trace approximations to calculate the trace approximation of the adjacency matrix (A).

In an embodiment, the calculations performed at equation (7) and/or equation (8) may be done in parallel on each processor included in the processor set. For example, if there are 10 processors in the processor set 114, the system 202 may perform 10 calculations in parallel to save the time. Furthermore, in some embodiment, the system 202 may be configured to select the subset of entries from the generated matrix-vector based on the determined computational power of the system. Specifically, the subset of entries to be selected may be equal to on a count of the processors included in the processor set. In another embodiment, the cardinality of the first set of natural numbers may be based on the number of processors in the processor set 114.

At 502H, a trace approximation storage operation may be executed. In the trace approximation storage operation, the system 202 may be configured to store the calculated trace approximation of the adjacency matrix. The system 202 may be further configured to generate a solution of the graph analysis problem based on the calculated trace approximation of the adjacency matrix. As discussed above, the graph analysis problem may correspond to one of a graph traversal problem, a network routing problem, a social network analysis problem, a protein folding problem, a graph centrality problem, a sorting problem, or a graph classification problem.

In another embodiment, the system 202 may be configured to render the calculated trace approximation on the display screen of the EUD 106. In another embodiment, the system 202 may be configured to render the generated solution of the graph analysis problem on the display screen of the EUD 106.

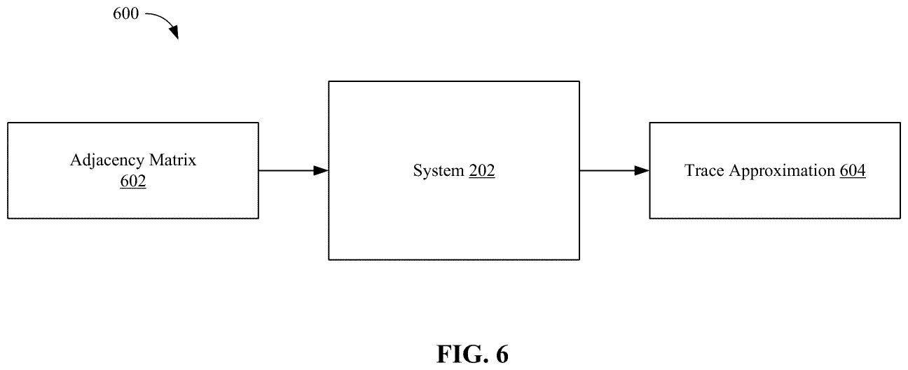

FIG. 6 is an exemplary diagram 600 that illustrates an exemplary use case scenario for randomized trace approximation, in accordance with an embodiment of the disclosure. FIG. 6 is explained in conjunction with elements from FIG. 1, FIG. 2, FIG. 3, FIG. 4A, FIG. 4B, and FIG. 5. With reference to FIG. 6, there is shown the exemplary diagram 600. With reference to FIG. 6, there is further shown an adjacency matrix 602 and a trace of the adjacency matrix 602. There is further shown the system 202 of FIG. 2 in FIG. 6.

As discussed above, the system 202 may be configured to retrieve the adjacency matrix 602 that may be associated with the complex graph. The retrieved adjacency matrix may be of a first dimension. In an embodiment, the system 202 may be configured to receive the adjacency matrix 602 from the EUD 106 associated with an end user (not shown). Details about the adjacency matrix 602 are provided, for example, in FIG. 4 and FIG. 5.

Based on the reception/retrieval of the adjacency matrix 602, the system 202 may be configured to determine the random vector based on the retrieved adjacency matrix. The determined random vector may have an expectation value of zero (0) and a variance of one (1). The system 202 may be further configured to generate the matrix-vector based on the retrieved adjacency matrix and the determined random vector. Details about the random vector and the matrix vector are provided, for example, in FIG. 5.

The system 202 may be further configured to determine a first set of natural numbers based on the first dimension of the retrieved adjacency matrix. The count of elements in the determined first set of natural numbers may be less than the first dimension of the retrieved adjacency matrix. The system 202 may be further configured to select the subset of entries from the generated matrix-vector based on the determined first set of natural numbers.

Based on the selection of the subset of entries, the system 202 may be configured to determine a diagonal random matrix based on a summation of canonical outer products formed by the selected subset of entries. The system 202 may be further configured to calculate a trace approximation 604 of the adjacency matrix based on the determined diagonal random matrix and the selected subset of entries. The system 202 may be further configured to store the calculated trace approximation of the adjacency matrix. In some embodiments, the system 202 may be further configured to output the calculated trace approximation of the adjacency matrix. In an embodiment, the output of the calculated trace approximation of the adjacency matrix may correspond to displaying of the calculated trace approximation on the display screen 204 of the EUD 106. In another embodiment, the output of the calculated trace approximation of the adjacency matrix may correspond to using the calculated trace approximation to generate a solution of a graph analysis problem associated with the complex graph. Details about the calculation of the trace approximation of the adjacency matrix are provided, for example, in FIG. 5.

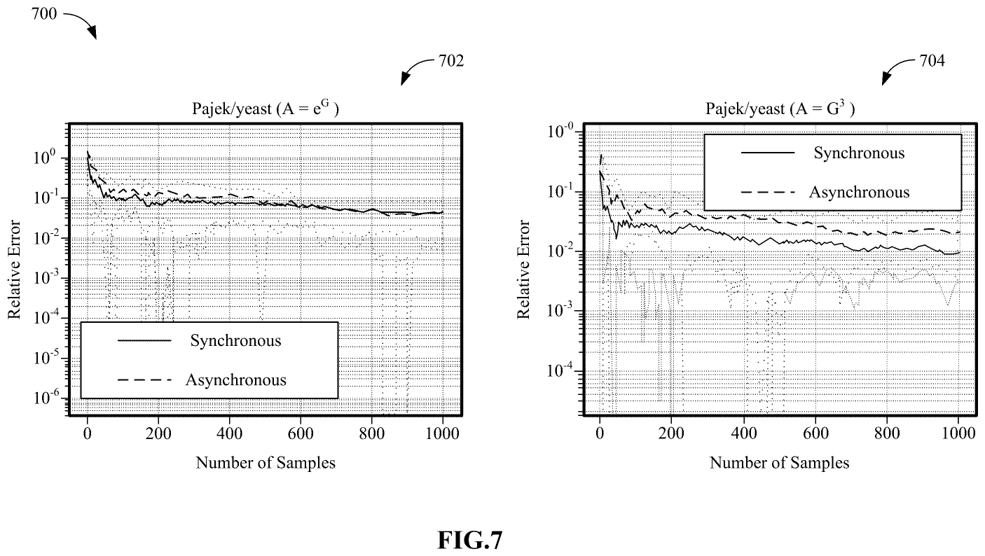

FIG. 7 is an exemplary diagram 700 of graphs between a number of samples and relative error, in accordance with an embodiment of the disclosure. FIG. 7 is explained in conjunction with elements from FIG. 1, FIG. 2, FIG. 3, FIG. 4A, FIG. 4B, FIG. 5, and. With reference to FIG. 7, there is further shown a first graph 702 and a second graph 704. The first graph 702 is associated with calculation of an Estrada index (e^{G}) where G is an adjacency matrix and the second graph 704 is associated with calculation of a cube of the matrix (G³).

In both the first graph 702 and the second graph 704, the results are depicted with respect to performance of the disclosed method (i.e. Asynchronous model) and the performance of the conventional methods (i.e. Synchronous model) for trace estimation. The result associated with the disclosed method (i.e. Asynchronous model) is represented by a solid line whereas the result associated with the conventional method (i.e. Synchronous model) is represented by a dotted line.

FIG. 8 is a flowchart 800 that illustrates an exemplary method for randomized trace approximation calculation based on asynchronous computing architecture, in accordance with an embodiment of the disclosure. FIG. 7 is explained in conjunction with elements from FIG. 1, FIG. 2, FIG. 3, FIG. 4A, FIG. 4B, FIG. 5, FIG. 6, and FIG. 7. With reference to FIG. 8, there is shown a flowchart 800. The operations of the exemplary method may be executed by any computing system, for example, by the computer 102 of FIG. 1 or the system 202 of FIG. 2. The operations of the flowchart 800 may start at 802.

At 802, an adjacency matrix associated with a complex graph may be retrieved. The retrieved adjacency matrix may be of a first dimension. In at least one embodiment, the system 202 may be configured to retrieve an adjacency matrix associated with the complex graph, wherein the retrieved adjacency matrix is of a first dimension. Details about the adjacency matrix are provided, for example, in FIG. 2, FIG. 3, and FIG. 5.

At 804, the random vector may be determined based on the retrieved adjacency matrix. The random vector may have an expectation value of zero. In at least one embodiment, the system 202 may be configured to determine the random vector based on the retrieved adjacency matrix, the random vector having an expectation value of zero. Details about the random vector are provided in FIG. 5.

At 806, the matrix-vector may be generated based on the retrieved adjacency matrix and the determined random vector. In at least one embodiment, the system 202 may be configured to generate the matrix-vector based on the retrieved adjacency matrix and the determined random vector.

At 808, a first set of natural numbers based on the first dimension of the retrieved adjacency matrix may be determined. A count of elements in the determined first set of natural numbers may be less than the first dimension of the retrieved adjacency matrix. In at least one embodiment, the system 202 may be configured to determine a first set of natural numbers based on the first dimension of the retrieved adjacency matrix, wherein a count of elements in the determined first set of natural numbers is less than the first dimension of the retrieved adjacency matrix.

At 810, a subset of entries from the generated matrix-vector may be selected based on the determined first set of natural numbers. In at least one embodiment, the system 202 may be configured to select the subset of entries from the generated matrix-vector based on the determined first set of natural numbers.

At 812, a diagonal random matrix may be determined based on a summation of canonical outer products formed by the selected subset of entries. In at least one embodiment, the system 202 may be configured to determine the diagonal random matrix based on the summation of canonical outer products formed by the selected subset of entries.

At 814, a trace approximation of the adjacency matrix may be calculated based on the determined diagonal random matrix and the selected subset of entries. In at least one embodiment, the system 202 may be configured to calculate the trace approximation of the adjacency matrix based on the determined diagonal random matrix and the selected subset of entries. In at least one embodiment, the system 202 may be configured to store the calculated trace approximation of the adjacency matrix.

At 816, the calculated trace approximation of the adjacency matrix may be stored. In at least one embodiment, the system 202 may be configured to store the calculated trace approximation of the adjacency matrix. Control may pass to the end.

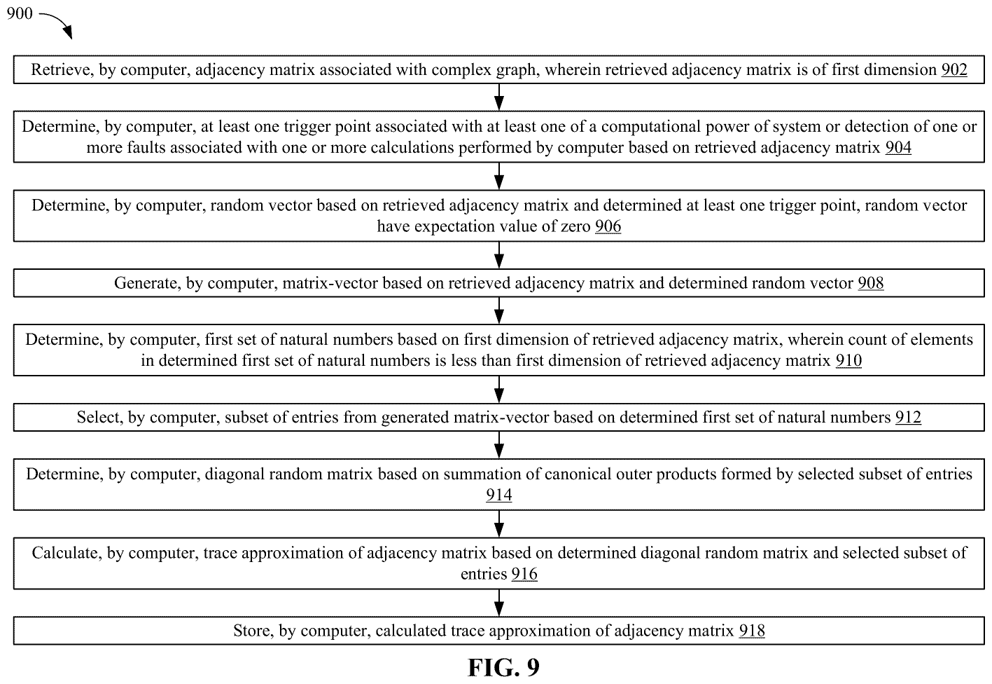

FIG. 9 is a flowchart 900 that illustrates an exemplary method for randomized trace approximation calculation based on asynchronous computing architecture, in accordance with an embodiment of the disclosure. FIG. 9 is explained in conjunction with elements from FIG. 1, FIG. 2, FIG. 3, FIG. 4A, FIG. 4B, FIG. 5, FIG. 6, FIG. 7, and FIG. 8. With reference to FIG. 9, there is shown a flowchart 900. The operations of the exemplary method may be executed by any computing system, for example, by the computer 102 of FIG. 1 or the system 202 of FIG. 2. The operations of the flowchart 900 may start at 902.

At 902, an adjacency matrix associated with a complex graph may be retrieved. The retrieved adjacency matrix may be of a first dimension. In at least one embodiment, the system 202 may be configured to retrieve an adjacency matrix associated with the complex graph, wherein the retrieved adjacency matrix is of a first dimension. Details about the adjacency matrix are provided, for example, in FIG. 2, FIG. 3, and FIG. 5.

At 904 at least one trigger point may be determined. The at least one trigger point may be associated with at least one of a computational power of the system or detection of one or more faults associated with one or more calculations performed by the computer based on the retrieved adjacency matrix. In an embodiment, the system 202 may be configured to compare the computational power of the system with a pre-determined computational power threshold. In case the computational power of the system is less than the pre-determined computational power threshold, then the at least one trigger point may be determined. Details about the computational power and the pre-determined computational power threshold are provided, for example, in FIG. 4A.

In another embodiment, the system 202 may be configured to compare the result generated by the application of the one or more mathematical operations on the acquired data with a ground truth. In case the generated result is not equal to the ground truth, then the at least one trigger point may be determined. Details about the generated result and the ground truth are provided, for example, in FIG. 4B. In at least one embodiment, the system 202 may be configured to determine at least one trigger point associated with at least one of a computational power of the system or detection of one or more faults associated with one or more calculations performed by the system based on the retrieved adjacency matrix.

At 906, the random vector may be determined based on the retrieved adjacency matrix and the determined at least one trigger point. The random vector may have an expectation value of zero. In at least one embodiment, the system 202 may be configured to determine the random vector based on the retrieved adjacency matrix and the determined at least one trigger point, the random vector having an expectation value of zero. Details about the random vector are provided in FIG. 5.

At 908, the matrix-vector may be generated based on the retrieved adjacency matrix and the determined random vector. In at least one embodiment, the system 202 may be configured to generate the matrix-vector based on the retrieved adjacency matrix and the determined random vector.

At 910, a first set of natural numbers based on the first dimension of the retrieved adjacency matrix may be determined. A count of elements in the determined first set of natural numbers may be less than the first dimension of the retrieved adjacency matrix. In at least one embodiment, the system 202 may be configured to determine a first set of natural numbers based on the first dimension of the retrieved adjacency matrix, wherein a count of elements in the determined first set of natural numbers is less than the first dimension of the retrieved adjacency matrix.

At 912, a subset of entries from the generated matrix-vector may be selected based on the determined first set of natural numbers. In at least one embodiment, the system 202 may be configured to select the subset of entries from the generated matrix-vector based on the determined first set of natural numbers.

At 914, a diagonal random matrix may be determined based on a summation of canonical outer products formed by the selected subset of entries. In at least one embodiment, the system 202 may be configured to determine the diagonal random matrix based on the summation of canonical outer products formed by the selected subset of entries.

At 916, a trace approximation of the adjacency matrix may be calculated based on the determined diagonal random matrix and the selected subset of entries. In at least one embodiment, the system 202 may be configured to calculate the trace approximation of the adjacency matrix based on the determined diagonal random matrix and the selected subset of entries. In at least one embodiment, the system 202 may be configured to store the calculated trace approximation of the adjacency matrix.

At 918, the calculated trace approximation of the adjacency matrix may be stored. In at least one embodiment, the system 202 may be configured to store the calculated trace approximation of the adjacency matrix. Control may pass to the end.

Various embodiments of the disclosure may provide a non-transitory computer readable medium and/or storage medium having stored thereon, instructions executable by a machine and/or a computer to operate a system (e.g., the system 202) for randomized trace approximation calculation based on asynchronous computing architecture. The instructions may cause the machine and/or computer to perform operations that include retrieving the adjacency matrix associated with a complex graph, wherein the retrieved adjacency matrix is of a first dimension. The operations further include determining a random vector based on the retrieved adjacency matrix, the random vector having an expectation value of zero. The operations further include generating a matrix-vector based on the retrieved adjacency matrix and the determined random vector. The operations further include determining a first set of natural numbers based on the first dimension of the retrieved adjacency matrix. A count of elements in the determined first set of natural numbers is less than the first dimension of the retrieved adjacency matrix. The operations further include controlling a first set of structures associated with the selected one or more image sensors to re-arrange the rig around the 3D physical space. The operations further include selecting a subset of entries from the generated matrix-vector based on the determined first set of natural numbers. The operations further include determining a diagonal random matrix based on a summation of canonical outer products formed by the selected subset of entries. The operations further include calculating the trace approximation of the adjacency matrix based on the determined diagonal random matrix and the selected subset of entries and storing the calculated trace approximation of the adjacency matrix.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for calculating a trace approximation of an adjacency matrix, the computer-implemented method comprising:
retrieving, by a computer, an adjacency matrix associated with a complex graph, wherein the retrieved adjacency matrix is of a first dimension;
determining, by the computer, a random vector based on the retrieved adjacency matrix, the random vector having an expectation value of zero;
generating, by the computer, a matrix-vector based on the retrieved adjacency matrix and the determined random vector;
determining, by the computer, a first set of natural numbers based on the first dimension of the retrieved adjacency matrix, wherein a count of elements in the determined first set of natural numbers is less than the first dimension of the retrieved adjacency matrix;
selecting, by the computer, a subset of entries from the generated matrix-vector based on the determined first set of natural numbers;
determining, by the computer, a diagonal random matrix based on a summation of canonical outer products formed by the selected subset of entries;
calculating, by the computer, a trace approximation of the adjacency matrix based on the determined diagonal random matrix and the selected subset of entries; and
storing, by the computer, the calculated trace approximation of the adjacency matrix.

2. The computer-implemented method of claim 1, further comprising generating, by the computer, a solution of a graph analysis problem based on the calculated trace approximation of the adjacency matrix, wherein the complex graph is associated with the graph analysis problem.

3. The computer-implemented method of claim 2, wherein the graph analysis problem corresponds to one of: a graph traversal problem, a network routing problem, a social network analysis problem, a protein folding problem, a graph centrality problem, a sorting problem, or a graph classification problem.

4. The computer-implemented method of claim 1, further comprising generating, by the computer, the matrix-vector based on the retrieved adjacency matrix, the determined random vector, and the first set of natural numbers, wherein at least one row of the retrieved adjacency matrix is updated by a zero-row vector in the generated matrix-vector based on a determination of an absence of a corresponding row number associated with the at least one row of an initial matrix-vector from the first set of natural numbers.

5. The computer-implemented method of claim 1, further comprising:
determining, by the computer, a computational power of at least one electronic device; and
selecting, by the computer, the subset of entries from the generated matrix-vector based on the determined computational power of the electronic device.

6. The computer-implemented method of claim 1, further comprising:
detecting, by the computer, one or more faults associated with one or more calculations performed by at least one electronic device; and
selecting, by the computer, the subset of entries from the generated matrix-vector based on the detection of the one or more faults.

7. The computer-implemented method of claim 1, further comprising:
iteratively selecting, by the computer, the subset of entries from the generated matrix-vector based on the determined first set of natural numbers;
iteratively determining, by the computer, the diagonal random matrix based on the summation of the canonical outer products formed by the corresponding subset of entries; and
calculating, by the computer, the trace approximation of the adjacency matrix based on an average of a set of intermediate results obtained based on the iterative selection of the subset of entries and the iterative determination of the diagonal random matrix.

8. The computer-implemented method of claim 1, wherein a variance of the determined random vector is equal to 1.

9. The computer-implemented method of claim 1, wherein the random vector is sampled based on one of a Rademacher distribution or a Gaussian distribution.

10. A system, comprising:
processor set configured to:
retrieve an adjacency matrix associated with a complex graph, wherein the retrieved adjacency matrix is of a first dimension;
determine a random vector based on the retrieved adjacency matrix, the random vector has an expectation value of zero;
generate a matrix-vector based on the retrieved adjacency matrix and the determined random vector;
determine a first set of natural numbers based on the first dimension of the retrieved adjacency matrix, wherein a count of elements in the determined first set of natural numbers is less than the first dimension of the retrieved adjacency matrix;
select a subset of entries from the generated matrix-vector based on the determined first set of natural numbers;
determine a diagonal random matrix based on a summation of canonical outer products formed by the selected subset of entries;
calculate a trace approximation of the adjacency matrix based on the determined diagonal random matrix and the selected subset of entries; and
store the calculated trace approximation of the adjacency matrix.

11. The system of claim 10, wherein the processor set is further configured to generate a solution of a graph analysis problem based on the calculated trace approximation of the adjacency matrix, wherein the complex graph is associated with the graph analysis problem.

12. The system of claim 11, wherein the graph analysis problem corresponds to one of: a graph traversal problem, a network routing problem, a social network analysis problem, a protein folding problem, a graph centrality problem, a sorting problem, or a graph classification problem.

13. The system of claim 10, wherein the processor set is further configured to generate the matrix-vector based on the retrieved adjacency matrix, the determined random vector, and the first set of natural numbers, wherein at least one row of the retrieved adjacency matrix is updated by a zero-row vector in the generated matrix-vector based on a determination of an absence of corresponding row number associated with the at least one row of an initial matrix-vector from the first set of natural numbers.

14. The system of claim 10, wherein the processor set is further configured to:
determine a computational power of the system; and
select the subset of entries from the generated matrix-vector based on the determined computational power of the system.

15. The system of claim 10, wherein the processor set is further configured to:
detect one or more faults associated with one or more calculations performed by the system; and
select the subset of entries from the generated matrix-vector based on the detection of the one or more faults.

16. The system of claim 10, wherein the processor set is further configured to:
iteratively select the subset of entries from the generated matrix-vector based on the determined first set of natural numbers;
iteratively determine the diagonal random matrix based on the summation of the canonical outer products formed by the corresponding subset of entries; and
calculate the trace approximation of the adjacency matrix based on an average of a set of intermediate results obtained based on the iterative selection of the subset of entries and the iterative determination of the diagonal random matrix.

17. The system of claim 10, wherein the processor set is further configured to:
select a subset of entries from the generated matrix-vector based on processor set information, wherein the processor set information indicates a count of processors in the processor set; and
determine the diagonal random matrix based on the summation of canonical outer products formed by the selected subset of entries.

18. The system of claim 10, wherein a variance of the determined random vector is equal to 1.

19. The system of claim 10, wherein the random vector is sampled based on one of: a Rademacher distribution or a Gaussian distribution.

20. A computer program product for calculating a trace approximation of an adjacency matrix, the computer program product comprising a computer-readable storage medium having program instructions embodied therewith, the program instructions executable by a system to cause the system to:
retrieving the adjacency matrix associated with a complex graph, wherein the retrieved adjacency matrix is of a first dimension;
determining a random vector based on the retrieved adjacency matrix, the random vector having an expectation value of zero;
generating a matrix-vector based on the retrieved adjacency matrix and the determined random vector;
determining a first set of natural numbers based on the first dimension of the retrieved adjacency matrix, wherein a count of elements in the determined first set of natural numbers is less than the first dimension of the retrieved adjacency matrix;
selecting a subset of entries from the generated matrix-vector based on the determined first set of natural numbers;
determining a diagonal random matrix based on a summation of canonical outer products formed by the selected subset of entries;
calculating the trace approximation of the adjacency matrix based on the determined diagonal random matrix and the selected subset of entries; and
storing the calculated trace approximation of the adjacency matrix.

21. A system, comprising:
processor set configured to:
retrieve an adjacency matrix associated with a complex graph, wherein the retrieved adjacency matrix is of a first dimension;
determine at least one trigger point associated with at least one of a computational power of the system or detection of one or more faults associated with one or more calculations performed by the system based on the retrieved adjacency matrix;
determine a random vector based on the retrieved adjacency matrix and the determined at least one trigger point, the random vector has an expectation value of zero;
generate a matrix-vector based on the retrieved adjacency matrix and the determined random vector;
determine a first set of natural numbers based on the first dimension of the retrieved adjacency matrix, wherein a count of elements in the determined first set of natural numbers is less than the first dimension of the retrieved adjacency matrix;
select a subset of entries from the generated matrix-vector based on the determined first set of natural numbers;
determine a diagonal random matrix based on a summation of canonical outer products formed by the selected subset of entries;
calculate a trace approximation of the adjacency matrix based on the determined diagonal random matrix and the selected subset of entries; and
store the calculated trace approximation of the adjacency matrix.

22. The system of claim 21, wherein the processor set is further configured to generate a solution of a graph analysis problem based on the calculated trace approximation of the adjacency matrix, wherein the complex graph is associated with the graph analysis problem.

23. The system of claim 22, wherein the graph analysis problem corresponds to one of: a graph traversal problem, a network routing problem, a social network analysis problem, a protein folding problem, a graph centrality problem, a sorting problem, or a graph classification problem.

24. The system of claim 21, wherein the processor set is further configured to:
compare the computational power of the system with a pre-determined computational power threshold; and
determine at least one trigger point based on the comparison.

25. A computer-implemented method for calculating a trace approximation of an adjacency matrix, the computer-implemented method comprising:
retrieving, by a computer, an adjacency matrix associated with a complex graph, wherein the retrieved adjacency matrix is of a first dimension;
determining, by the computer, at least one trigger point associated with at least one of a computational power of the system or detection of one or more faults associated with one or more calculations performed by the computer based on the retrieved adjacency matrix;
determining, by the computer, a random vector based on the retrieved adjacency matrix and the determined at least one trigger point, the random vector has an expectation value of zero;
generating, by the computer, a matrix-vector based on the retrieved adjacency matrix and the determined random vector;
determining, by the computer, a first set of natural numbers based on the first dimension of the retrieved adjacency matrix, wherein a count of elements in the determined first set of natural numbers is less than the first dimension of the retrieved adjacency matrix;
selecting, by the computer, a subset of entries from the generated matrix-vector based on the determined first set of natural numbers;
determining, by the computer, a diagonal random matrix based on a summation of canonical outer products formed by the selected subset of entries;
calculating, by the computer, a trace approximation of the adjacency matrix based on the determined diagonal random matrix and the selected subset of entries; and
storing, by the computer, the calculated trace approximation of the adjacency matrix.
